(19) United States
(12) Patent Application Publication
(10) Pub. No.: US 2016/0332287 A1
(43) Pub. Date: Nov. 17, 2016

(54) PNEUMATIC WRENCH WITH BUTTERFLY STEERING SWITCHING MECHANISM

(71) Applicant: YEAR CONGRATULATE INDUSTRIAL CO., LTD., Taoyuan City (TW)

(72) Inventor: Chi-Chen Chen, Taoyuan City (TW)

(21) Appl. No.: 14/745,303

(22) Filed: Jun. 19, 2015

(30) Foreign Application Priority Data
May 13, 2015 (TW) 104207363

(51) Int. Cl. B25B 21/02; B25F 5/02; B25F 5/00

(52) U.S. Cl. CPC B25B 21/02; B25F 5/001; B25F 5/02

(57) ABSTRACT

A pneumatic wrench with a butterfly steering switching mechanism includes a casing, a striking module, a motor module, a back cover, a butterfly operating lever, a speed control knob, a flow control valve, a forward/reverse rotary valve, a trigger module, and an air seal module. The novel design of the butterfly operating lever, the alternate installation of each mechanism of the wrench, and the optimal configuration of the air passage provide a wrench that can be operated by one hand for left and right handed operator and achieve the effects of lowering the production cost of a casing blank, improving the transmission loss compressed air in the wrench, and saving energy.

The current application claims a foreign priority to the patent application of Taiwan No. 104207363 filed on May 13, 2015.

### FIELD OF THE INVENTION

The present invention relates to the field of a pneumatic wrench, in particular to the pneumatic wrench with a butterfly steering switching mechanism.

### BACKGROUND OF THE INVENTION

According to the working principle of a pneumatic wrench, compressed air is passed through an air seal mechanism, a speed control mechanism, and a forward/reverse mechanism and pushed into a cylinder to drive a vane to rotate a rotor, so as to generate high-power alternating impact loads instantaneously from a striking mechanism. With the features of large torque output and excellent safety, the pneumatic wrench is used extensively for installing and removing screws at assembly and product lines and maintenance and repair sites.

The conventional pneumatic wrench is generally divided into following two types: 1. A speed-control pneumatic wrench has a forward/reverse mechanism disposed at a rear end of the wrench, so that when the speed of the wrench is adjusted, or the forward/reverse rotation is switched, the operation has to be done by both hands. 2. A speed adjusting pneumatic wrench has a word/reverse mechanism and a trigger disposed adjacent to each other and aligned linearly, and the forward/reverse rotation is switched by turning the operating lever, and such wrench is known as the one-hand operating wrench. Specifically, the operating lever of this design may affect the effect of holding the handle due to the operating lever, so that the operating lever must be arranged on a side of the wrench only, and a general operating lever is generally installed on a side near an operator's thumb after the user holds the pneumatic wrench by hand, so that the operator may switch to a forward or reverse rotation of the pneumatic wrench by using the thumb. According to the using habit of the operator, a right-hand wrench is unable to meet the operation for a left hand operation, since the switch operating lever of the right-hand wrench may be turned by the thumb, but after the user holds the pneumatic wrench by the left hand, the switch operating lever will be situated on a side of the palm, and the thumb will be unable to complete the switching operation, and the switch operating lever is interfered by the index finger. As a result, the operator cannot pull the trigger by the index finger easily. In other words, the pneumatic wrench must be designed with left and right structures in order to achieve the one-handed operation, and thus bringing tremendous inconvenience to manufacturers and end-users.

Therefore, the conventional pneumatic wrench has the drawbacks of unable to provide a one-handed operation for all functions or allow left-hand or right-hand operators to share the same wrench.

### SUMMARY OF THE INVENTION

In view of the aforementioned drawbacks of the prior art, it is a primary objective of the present invention to provided a pneumatic wrench with a butterfly steering switching mechanism that optimizes and improves each mechanical structure of the conventional pneumatic wrench by adopting a butterfly operating lever to switch the forward or reverse operation and allow a left-handed or right-handed operator to accomplish all functions by the one-handed operation.

To achieve the aforementioned objective, the present invention provides a pneumatic wrench with a butterfly steering switching mechanism comprising a casing, a striking module, a motor module, a back cover, a back cover paper pad, an air seal module, an air seal washer, a hollow pin A, a speed control knob, a gear spring A, a steel ball A, a butterfly operating lever, a gear spring B, a steel ball B, a gasket A, a forward/reverse rotary valve, a gasket B, a flow control valve, a hollow pin B, a trigger module, a hollow pin C, a screw, and a spring washer. The casing includes an air intake hole of the handle pressed by an air seal washer, and the air seal module is locked into the handle air intake hole through the pipe joint and the natural status is always closed. The striking module and the motor module are installed into casing large inner hole sequentially and serially, and the back cover is provided for sealing the motor module and the striking module in the casing by the screw and spring washer, and a back cover paper pad is sealed between the casing and the back cover. An exhaust slot A, a forward air tank A and a reverse air tank A are disposed on the rear surface of the casing corresponsive to the forward air tank B and reverse air tank B of the back cover, and a forward air tank B and a reverse air tank B are disposed on an end surface of the back cover and corresponsive to a forward air tank C and a reverse air tank C of the motor module. A trigger module mounting hole is formed at the front of the casing for installing the trigger module therein, and an air intake ejector is installed at the rear of the trigger module, such that when the trigger module is pressed, the air intake ejector pushes and opens the air intake valve in the air seal module to input air and operate the pneumatic wrench, and when the trigger module is released, the air intake valve and the trigger module resume their natural status to achieve the effect of stopping the operation of the pneumatic wrench under the effect of the return spring in the air seal module, and a forward/reverse speed control assembly mounting hole is formed above the trigger module mounting hole of the casing and has a forward/reverse speed control assembly formed therein, and the forward/reverse speed control assembly includes a hollow pin A, a speed control knob, a butterfly operating lever, a forward/reverse rotary valve, a gasket A and a flow control valve, and the speed control knob and the butterfly operating lever are disposed outside the forward/reverse speed control assembly mounting hole, and a forward/reverse speed control assembly mounting hole is formed above the trigger module mounting hole of the casing and provided for installing the forward/reverse speed control assembly therein, and the speed control knob and the butterfly operating lever of the forward/reverse speed control assembly are disposed outside the casing, and a latch groove is formed at the middle of the butterfly operating lever and operated closely with a square head at a small end of the forward/reverse rotary valve. By turning the butterfly operating lever, the forward/reverse rotary valve is driven to rotate axially to achieve the effect of switching to a forward or reverse rotation of the wrench. A radial hole A is formed at the external periphery of the forward/reverse rotary valve, and three different sized radial holes B are formed at the external periphery of the flow control valve, and the small end of the flow control valve is passed through the gasket B at the inner hole of the forward/reverse rotary valve, and a passing-out end of the flow control valve is sheathed by the inner hole C of the speed control knob and fixed by a hollow pin A. The speed control knob may be turned, so that one of the radial holes B of the flow control valve is communicated with the radial hole A of the forward/reverse rotary valve to control the airflow, so as to achieve the speed control effect of the wrench.

An exhaust slot A is formed at a rear end surface of the casing and communicated with the bottom of the large inner hole. An exhaust oblique hole is drilled at the exhaust slot A of the casing and penetrated through the forward/reverse speed control assembly mounting hole of the casing and the exhaust hole at the handle of the casing. Both sides of the exhaust slot A of the casing have a forward air tank A and a reverse air tank A respectively. After the assembling, the air tanks are communicated with the forward air tank B and the reverse air tank B formed on an end surface of the back cover. The handle of the casing has an air intake hole penetrated through an air chamber at the bottom of the forward/reverse speed control assembly mounting hole. The forward/reverse speed control assembly mounting hole of the casing has a forward oblique hole and a reverse oblique hole, wherein the forward oblique hole is penetrated from the outer side of the handle of the casing to the forward air tank A. Similarly, the reverse oblique hole is penetrated to the reverse air tank A and the forward rotation hole on a sidewall of the handle. The reverse rotation hole has a plug for sealing air. A limiting hole is formed at the top of the forward/reverse speed control assembly mounting hole of the casing, and a forward/reverse limiting projection, a forward gear slot and a reverse gear slot are formed at the top of the front end of the forward/reverse speed control assembly mounting hole of the casing, and a trigger module mounting hole and a trigger module limiting hole are formed at the bottom of the forward/reverse speed control assembly mounting hole of the casing.

A forward air tank B, a reverse air tank B, and an exhaust slot B are formed on an end surface of the back cover. After assembling, the forward air tank B and the reverse air tank B of the back cover are communicated with the forward air tank A and the reverse air tank A of the casing and the forward air tank C and the reverse air tank C of the motor module, and back cover paper pad is sealed between them.

A stepped inner hole A, a stepped inner hole B, and an inner hole A are formed at the axis of the forward/reverse rotary valve. A radial hole A, an exhaust slot C, and a gasket slot are formed at the external periphery of the forward/reverse rotary valve. A double-planed square head is formed at the external periphery of the small end of the forward/reverse rotary valve. The forward/reverse rotary valve is installed in the forward/reverse speed control assembly mounting hole of the casing, and the limiting hole of the casing is inserted with a hollow pin B, so that the forward/reverse rotary valve will not be blown away from the casing by the compressed air. The gasket slot of the forward/reverse rotary valve is provided for installing a gasket A, so that the compressed air will not leak from the forward/reverse speed control assembly mounting hole of the casing. When the forward/reverse rotary valve radial hole A is communicated with the forward oblique hole or the reverse oblique hole of the casing, the reverse oblique hole or the forward oblique hole formed on the casing is communicated with the exhaust slot C of the forward/reverse rotary valve.

Both sides of the butterfly operating lever have a side arm, and an end of the side arm is in the form of an inwardly concave arc, and a speed control gear label A is disposed on an end surface of the side arm, and the butterfly operating lever includes a latch groove formed at the middle of the butterfly operating lever, and a forward/reverse gear hole is formed at the external periphery of the butterfly operating lever, and a speed control gear hole is formed on an end surface of the butterfly operating lever. The gear spring A and the steel ball A are installed in the speed control gear hole and operated together with three recession holes of the speed control knob to control the speed control gear precisely. The gear spring B and the steel ball B are installed in the forward/reverse gear hole and operated together with the forward and reverse gear slot of the casing to control the forward/reverse gear precisely. Both side arms of the butterfly operating lever are disposed at the bottom of the forward/reverse limiting projection of the casing to prevent an over-adjustment of the forward/reverse rotation. The latch groove formed at the middle of the butterfly operating lever is operated together with the small end of the forward/reverse rotary valve, and both side arms of the butterfly operating lever may be turned to drive the middle latch groove to rotate the forward/reverse rotary valve. When the steel ball B in the forward/reverse gear hole is latched into the forward and reverse gear slot of the casing under the effect of the gear spring B, the radial hole A at the external periphery of the forward/reverse rotary valve is communicated precisely with the forward oblique hole or the reverse oblique hole of the casing to achieve the effect of switching to a forward or reverse rotation of the wrench.

The flow control valve has an inner hole B formed at the axis of the flow control valve. The external periphery of the flow control valve is divided into three sections. A positioning hole A is formed at the external periphery of a small section, and three different sized radial holes B are formed at the external periphery of a middle section, and the flow control valve is passed into the inner hole A of the forward/reverse rotary valve, and the external periphery of a large section is latched into the stepped inner hole A of the forward/reverse rotary valve to prevent the flow control valve from being blown away by compressed air. A gasket B is installed at the small section of the external periphery of the flow control valve and sealed with the stepped inner hole B of the forward/reverse rotary valve to prevent the compressed air from escaping from the inner hole A of the forward/reverse rotary valve.

The speed control knob has an anti-slip pattern and a positioning hole B formed at the external periphery, three recession holes formed on an end surface, and a speed control gear label B disposed on the other end surface. The inner hole C of the speed control knob is configured to be corresponsive to the small section of the external periphery of the flow control valve, and a hollow pin A is installed into the positioning hole B and the flow control valve positioning hole A, so that the speed control knob and the flow control valve become a whole. Now, an included angle is defined between the three recession holes on an end surface of the speed control knob and the three radial holes B at the external periphery of the flow control valve. The speed control knob may be turned to rotate, and the flow control valve is driven to rotate altogether. When the speed control knob is rotated until the steel ball A in the speed control gear hole formed at an end surface of the butterfly operating lever is latched into a certain recession hole formed on an end surface of the speed control knob under the effect of the gear spring A, the radial hole B corresponsive to the external periphery of the flow control valve and the recession hole of the speed control knob are communicated precisely with the radial hole A of the forward/reverse rotary valve, so as to control the airflow for the speed control of the wrench.

An air intake ejector is installed at the rear end of the trigger module, and a limiting groove is formed at the top of the trigger module. During assembling, the trigger module is installed in the trigger module mounting hole of the casing, and a hollow pin C is installed into the trigger module limiting hole of the casing and passed through the limiting groove of the trigger module to prevent the trigger module from separating from the casing during the use of the pneumatic wrench. When the trigger module is pressed, the air intake ejector pushes and opens the air intake valve in the air seal module to input air and operate the wrench. When the external force of the trigger module is released, the trigger module is pushed by the air intake valve to resume its original position under the effect of the return spring in the air seal module, and the air intake valve and the air seal washer resume their air seal status. Now, the wrench stops its operation.

The air flow of the pneumatic wrench with a butterfly steering switching mechanism of the present invention is described as follows.

1. In the air intake process, after the trigger module is pressed, the air intake valve is pushed open, and compressed air is passed through the air seal module and the air seal washer to enter into the air chamber of the casing through the radial hole B of the flow control valve, the radial hole A of the forward/reverse rotary valve, the forward oblique hole of the casing to the forward air tank A of the casing, and then to enter into the motor module through the back cover paper pad, the forward air tank B of the back cover, and the forward air tank C of the motor module, so that the motor module drives the striking module to rotate clockwise.

2. In the air exhaust process, the air exhaust process is divided into two sections: \textcircled{1} Some of the exhaust air is discharged from the exhaust hole of the motor and entered into the forward/reverse speed control assembly mounting hole of the casing through the casing exhaust slot A and the oblique exhaust hole of the casing, and passed around the exhaust slot C of the forward/reverse rotary valve and entered into the exhaust hole of the handle of the casing, and finally discharged to the outside. \textcircled{2} The remaining exhaust air is discharged from the reverse air tank C of the motor module, and passed through the back cover paper pad into the reverse air tank B of the back cover, the reverse air tank A of the casing, the reverse oblique hole of the casing, the forward/reverse speed control assembly mounting hole of the casing, and passed around the exhaust slot C of the forward/reverse rotary valve into the exhaust hole of the handle of the casing, and finally discharged to the outside. The compressed air flows along the aforementioned path to keep a continual operation of the wrench. When it is necessary to switch the rotating direction, the operator simply turns the butterfly operating lever to the other side, and the principle of operation is the same as described above.

The positive effects of the present invention are described below:

1. The pneumatic wrench with the novel design of the butterfly operating lever is provided for left-handed and right-handed operators to share the same wrench.

2. The pneumatic wrench with the misalignment of different mechanical structures allows operators to turn on/off the wrench, adjusting the speed, or switching to the forward or reverse rotation with the one-handed operation without changing the holding posture by designing the forward/reverse mechanism above the trigger.

3. The pneumatic wrench has the manufacturing holes designed on the sidewall of the handle, so that the blank of the casing can be formed by pressure casting to overcome the drawbacks such as the low efficiency and high cost of the traditional gravitational casting method

4. The pneumatic wrench with improved mechanical parts, the air passage structure is compact, so that the loss of compressed air occurred during the internal transmission of the wrench is reduced to save energy.

### BRIEF DESCRIPTION OF THE DRAWINGS

FIG. 1 is an exploded view of the present invention;

FIG. 2 is another exploded view of the present invention;

FIG. 3 is a rear view of a casing of the present invention;

FIG. 4 is a cross-sectional view of Section A-A of a casing of the present invention;

FIG. 5 is a cross-sectional view of Section B-B of a casing of the present invention;

FIG. 6 is a P-direction view of a casing of the present invention;

FIG. 7 is a partial exploded view of the present invention;

FIG. 8 is another partial exploded view of the present invention;

FIG. 9 is a cross-sectional view of Section B-B of a forward/reverse rotary valve of the present invention;

FIG. 10 is a cross-sectional view of Section A-A of a forward/reverse rotary valve of the present invention;

FIG. 11 is a schematic view of a forward/reverse rotary valve of the present invention;

FIG. 12 is a schematic view showing the working position of a forward/reverse rotary valve of the present invention;

FIG. 13 is a schematic view of a butterfly operating lever of the present invention;

FIG. 14 is a schematic view showing the working position of a forward/reverse speed control element butterfly operating lever of the present invention;

FIG. 15 is a schematic view showing the working position of a butterfly operating lever of the present invention;

FIG. 16 is a schematic view of a flow control valve of the present invention;

FIG. 17 is a cross-sectional view of Section A-A of a flow control valve of the present invention;

FIG. 18 is a rear view of a speed control knob of the present invention;

FIG. 19 is a schematic view of Section A-A of a speed control knob of the present invention;

FIG. 20 is a front view of a speed control knob of the present invention;

FIG. 21 is a schematic view of a trigger module of the present invention;

FIG. 22 is a schematic view showing the working position of a trigger module of the present invention;

FIG. 23 is a schematic view of an airflow produced in a forward air intake process of the present invention;

FIG. 24 is a schematic view of a portion of a flow of exhaust air produced in a forward air discharge process of the present invention; and

FIG. 25 is a schematic view of the remaining portion of the flow of exhaust air produced in a forward air discharge process of the present invention.

### DESCRIPTION OF THE PREFERRED EMBODIMENTS

The aforementioned and other objectives and advantages of the present invention will become clearer in light of the following detailed description of an illustrative embodiment of this invention described in connection with the drawings. It is intended that the embodiments and drawings disclosed herein are to be considered illustrative rather than restrictive.

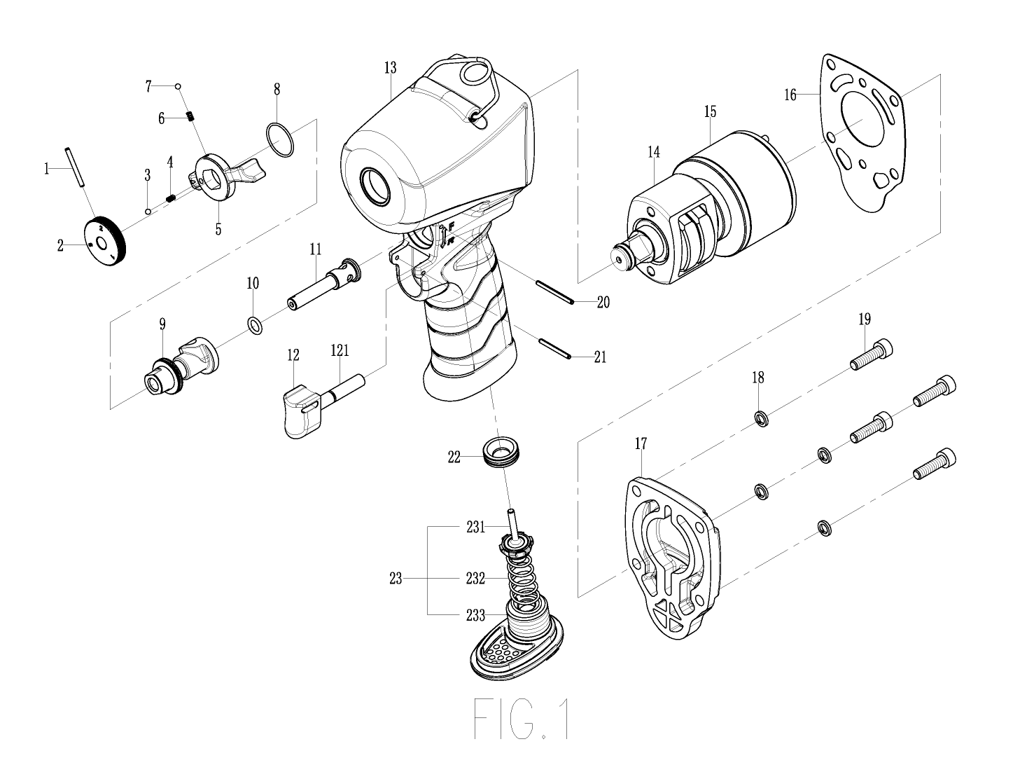

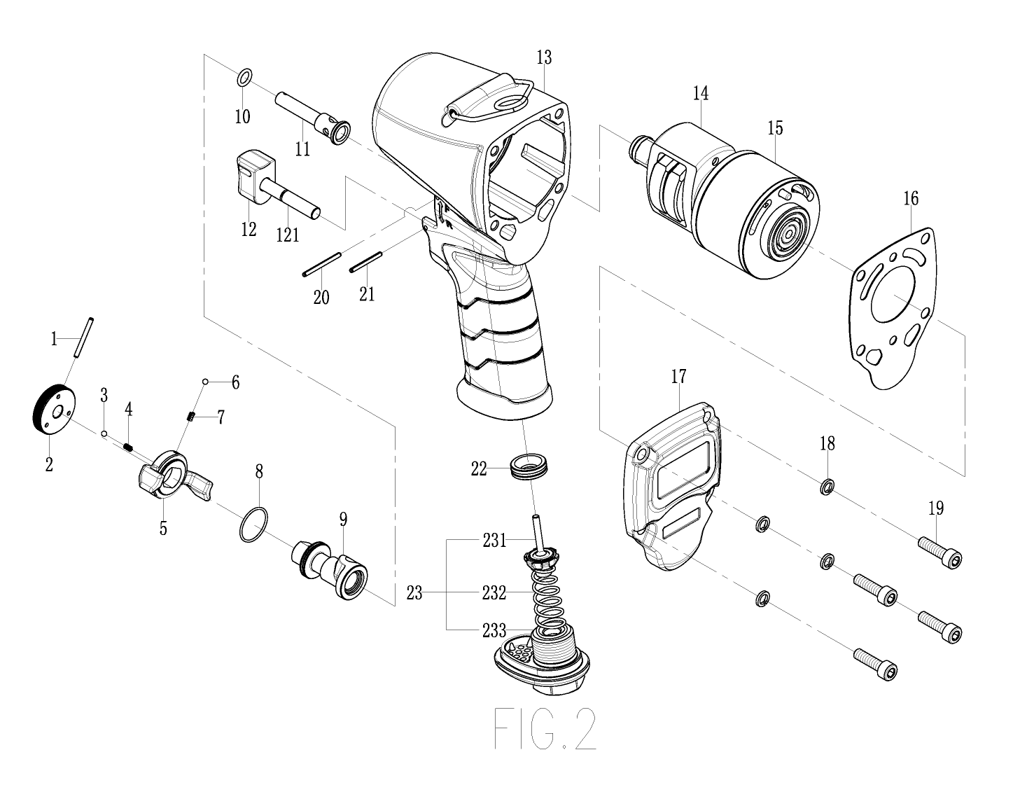

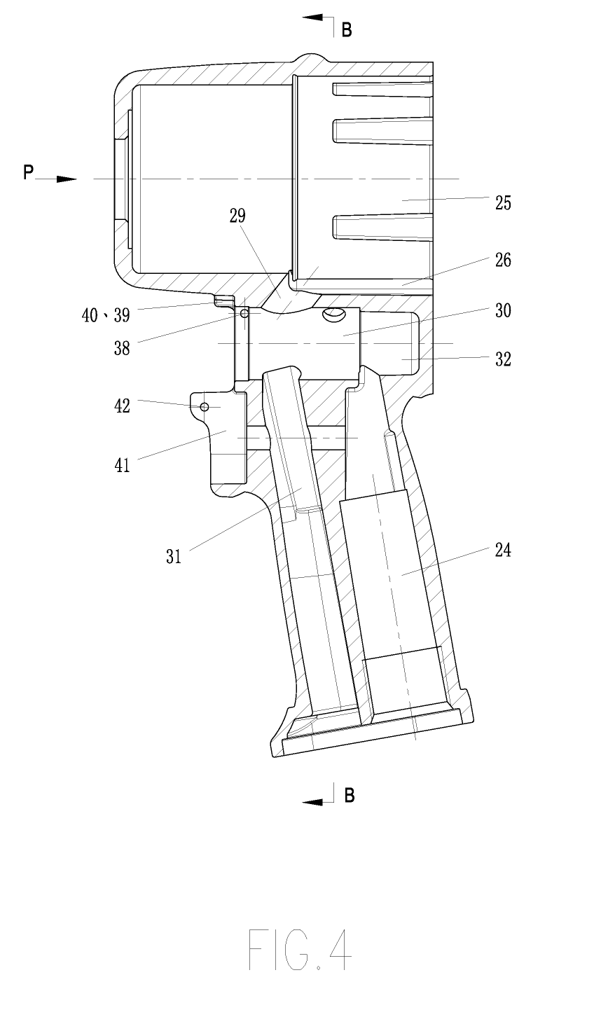

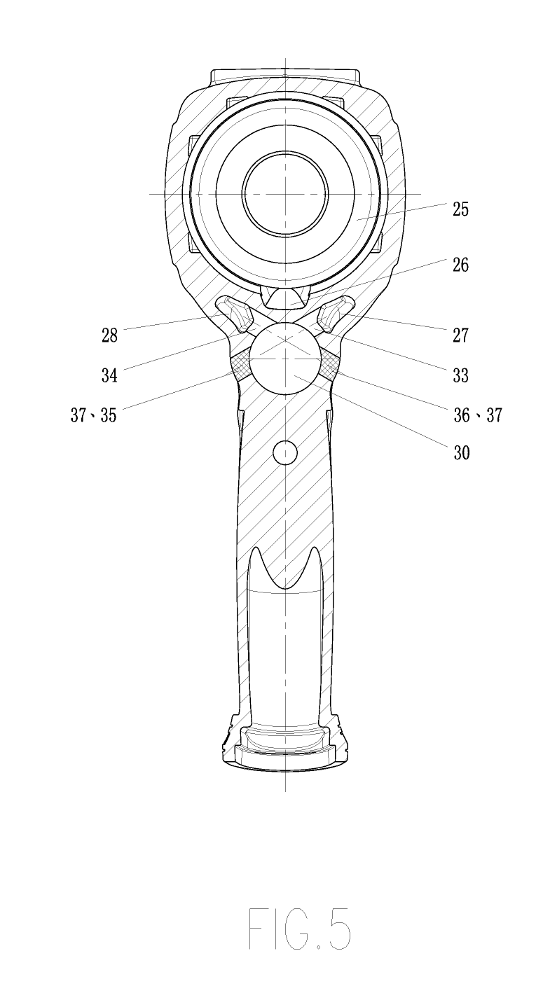

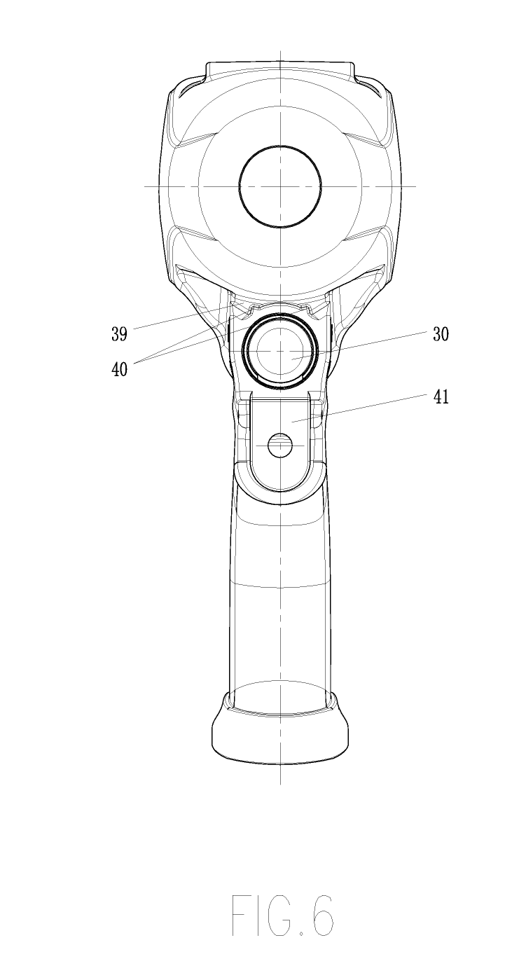

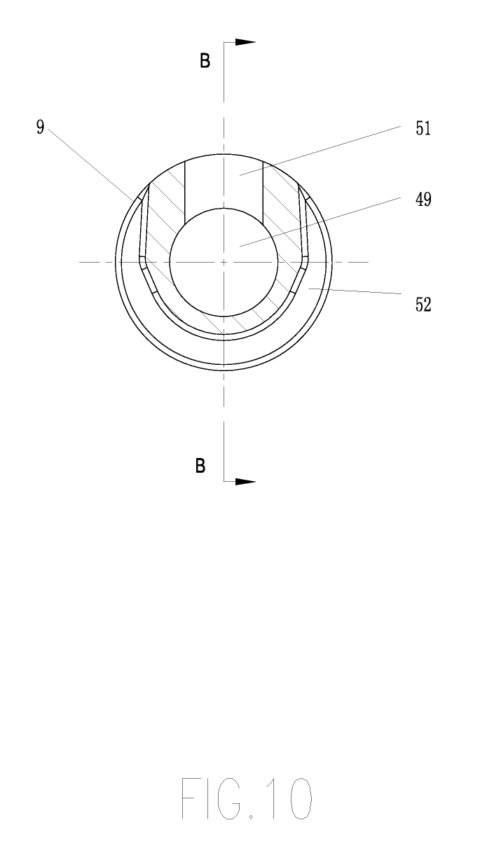

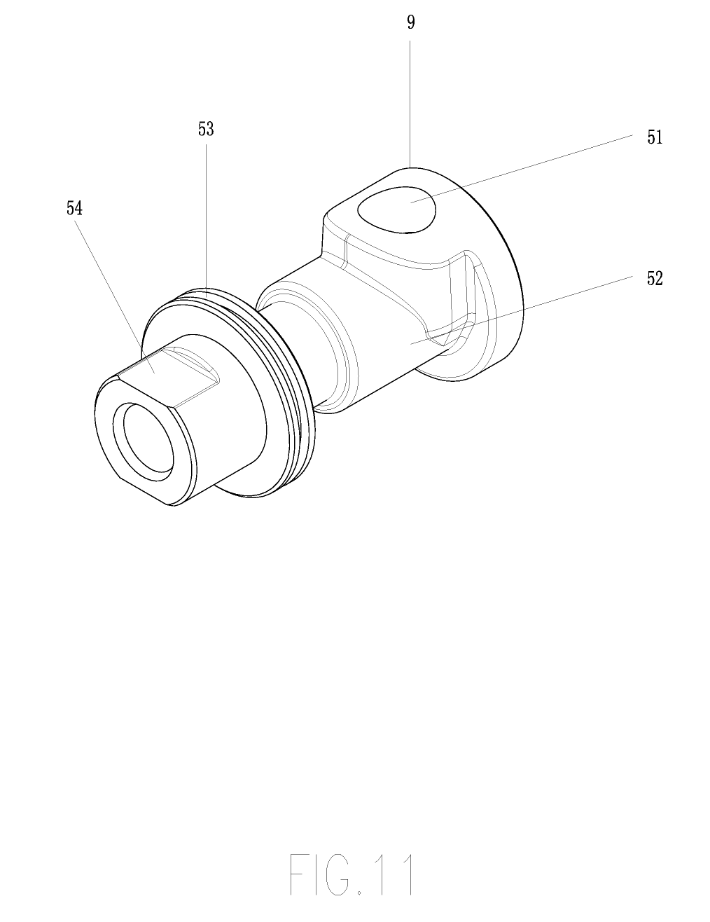

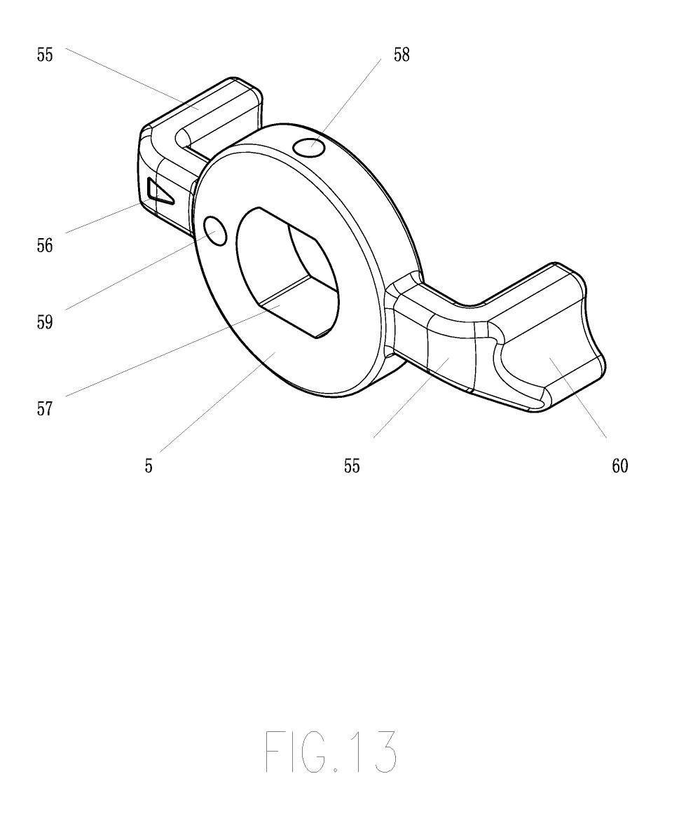

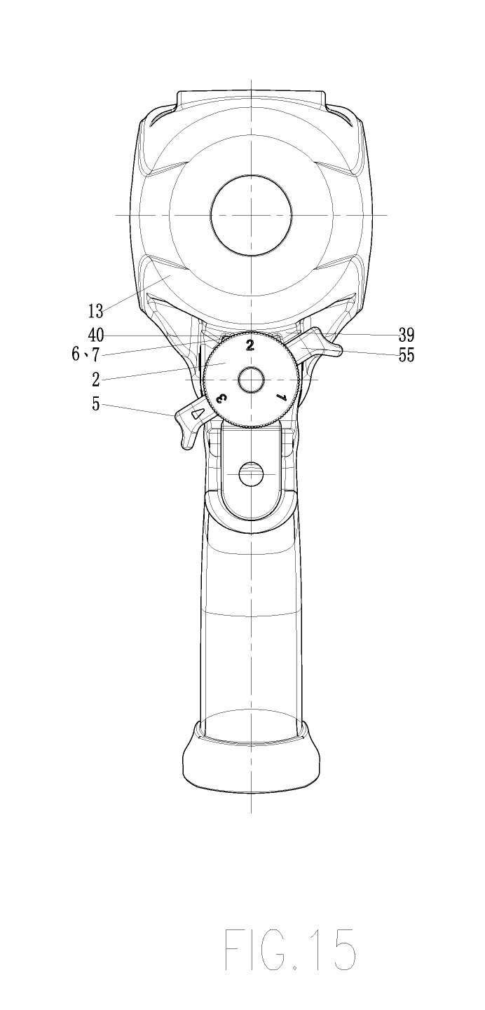

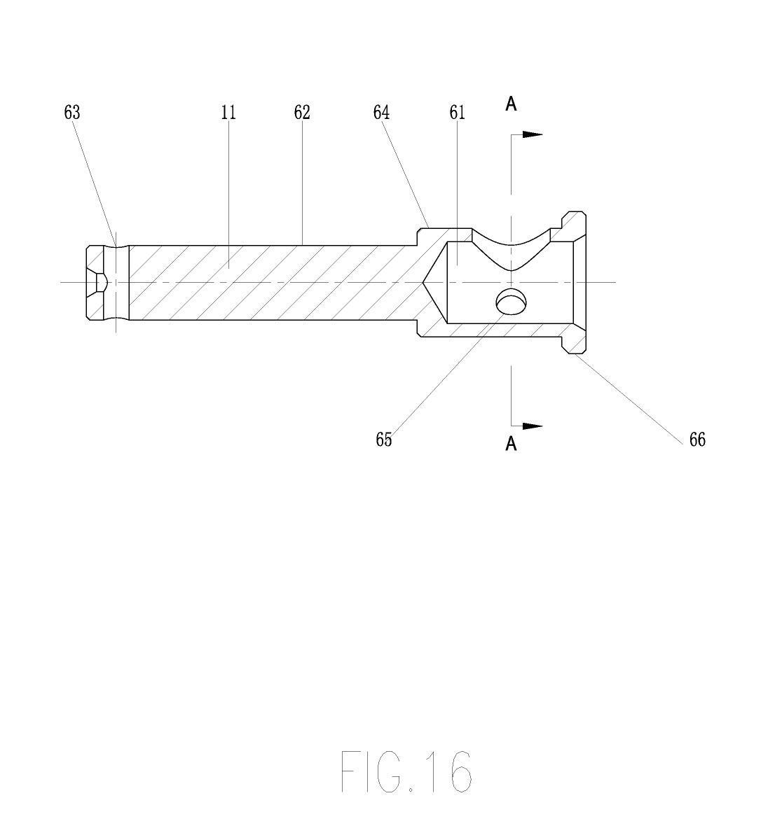

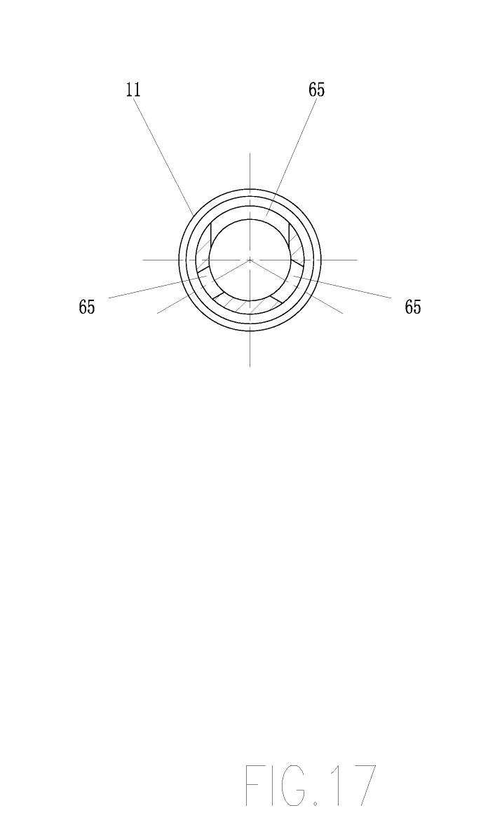

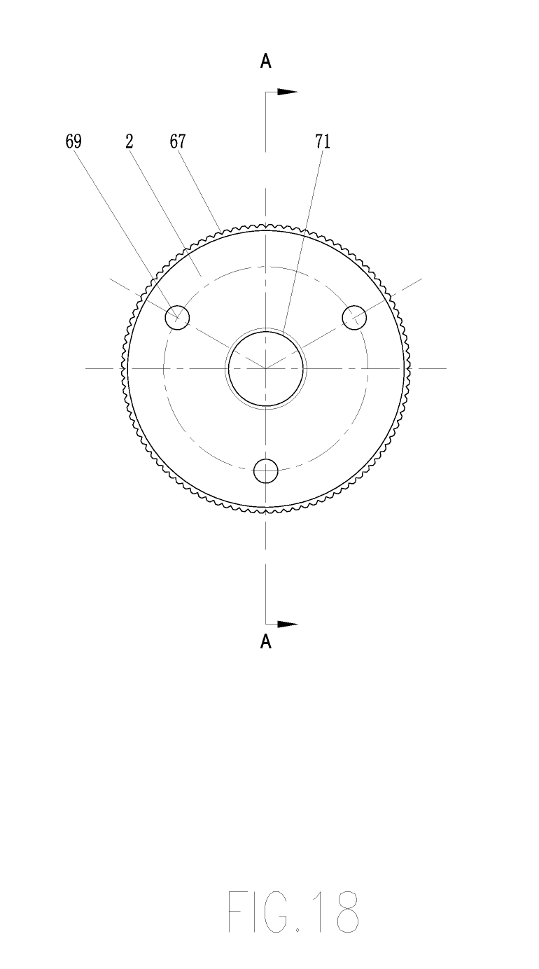

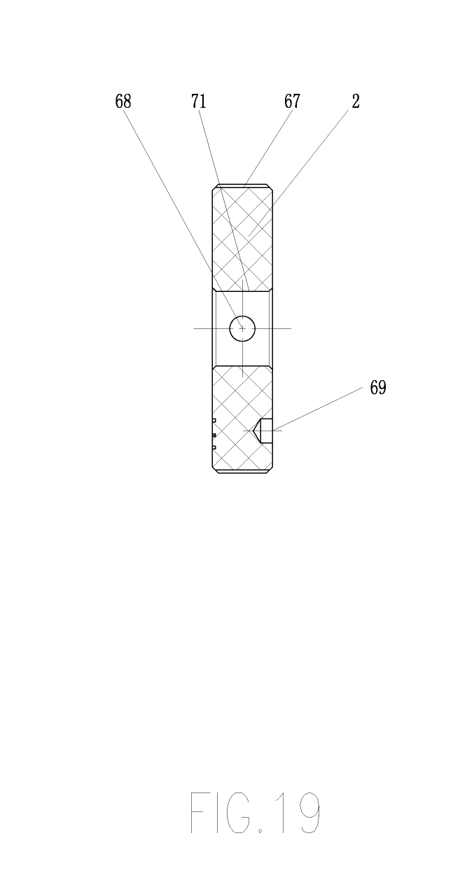

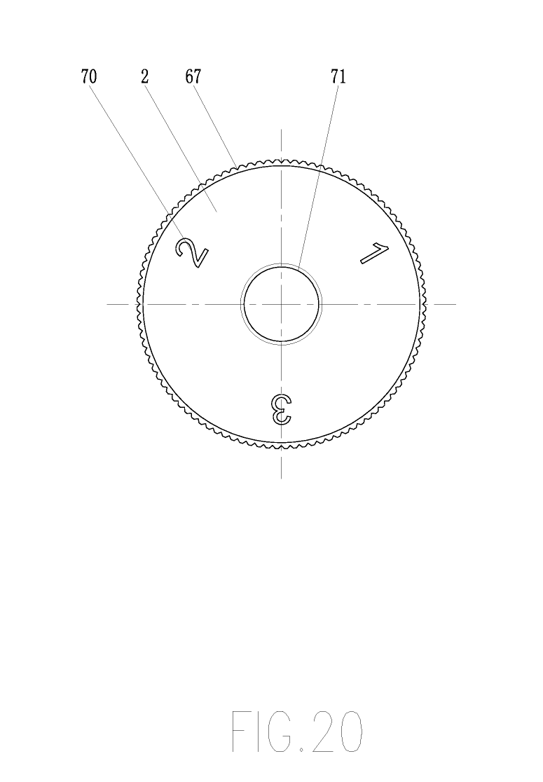

With reference to FIGS. 1 to 22 for a pneumatic wrench with a butterfly steering switching mechanism in accordance with the present invention, the pneumatic wrench comprises a casing 13, a striking module 14, a motor module 15, a back cover 17, a back cover paper pad 16, an air seal module 23, an air seal washer 22, a forward/reverse speed control assembly, a trigger module 12, a hollow pin C21, a plurality of screws 19, and a plurality of spring washers 18. A handle air intake hole 24 is formed at the bottom of the casing 13, and an air seal washer 22 is pressed into the handle air intake hole 24, and an air seal module 23 is locked tightly into the handle air intake hole 24 through a pipe joint 233, and the natural status is always closed. The casing 13 includes a large inner hole 25 formed therein, and the striking module 14 and the motor module 15 are installed sequentially and serially into a large inner hole 25, and the back cover 17 is provided for sealing the motor module 14 and the striking module 15 into the casing 13 by the screws 19 and the spring washers 18, and a back cover paper pad 16 is sealed between the casing 13 and the back cover 17. In addition, an exhaust slot A26, a forward air tank A27 and a reverse air tank A28 are formed at the rear end surface of the casing 13, and a forward air tank B43 and a reverse air tank B44 are disposed on an end surface of the back cover 17, and the forward air tank A27 and the reverse air tank A28 of the casing 13 are corresponsive to the forward air tank B43 and the reverse air tank B44 of the back cover 17 respectively. The motor module 15 includes a forward air tank

C46 and a reverse air tank C46 corresponsive to the forward air tank B43 and the reverse air tank B44 of the back cover 17 respectively. A trigger module mounting hole 41 is formed at the front of the casing 13 and provided for installing the trigger module 12 therein, and an air intake ejector 121 is installed at the rear end of the trigger module 12. The air seal module 23 includes an air intake valve 231, a return spring 232 and a pipe joint 233. When the trigger module 12 is pressed, the air intake ejector 121 pushes and opens the air intake valve 231 in the air seal module 23 to drive the pneumatic wrench to input air and operate. When the trigger module 12 is released, the air intake valve 231 and the trigger module 12 resume their natural status under the effect of the return spring 232 in the air seal module 23, so that the pneumatic wrench stops its operation. A forward/reverse speed control assembly mounting hole 30 is formed above the trigger module mounting hole 41 of the casing 13, and the forward/reverse speed control assembly mounting hole 30 includes a forward/reverse speed control assembly, and the forward/reverse speed control assembly includes a hollow pin A1, a speed control knob 2, a gear spring A4, a steel ball A3, a butterfly operating lever 5, a gear spring B6, a steel ball B7, a gasket A8, a forward/reverse rotary valve 9, a gasket B10, a flow control valve 11 and a hollow pin B20, wherein the speed control knob 2 and the butterfly operating lever 5 are disposed outside the forward/reverse speed control assembly mounting hole 30. The forward/reverse rotary valve 9 and the flow control valve 11 are installed in the forward/reverse speed control assembly mounting hole 30, and the speed control knob 2 has an inner hole C71 formed therein, and the middle of the butterfly operating lever 5 has a latch groove 57, and a small end of the forward/reverse rotary valve 9 is substantially a square head, and the latch groove 57 of the butterfly operating lever 5 is operated closely with the square-head small section of the forward/reverse rotary valve 9. The butterfly operating lever 5 may be turned to drive the forward/reverse rotary valve 9 to rotate axially to achieve the effect of switching to a forward or reverse rotation of the wrench. A radial hole A51 is formed at the external periphery of the forward/reverse rotary valve 9, and the forward/reverse rotary valve 9 has an inner hole A50 formed therein, and three different sized radial holes B65 are formed at the external periphery of the flow control valve 11, and the small end of the flow control valve 11 is passed through the gasket B10 and sheathed by an inner hole A50 of the forward/reverse rotary valve 9, and the passing-out end of the flow control valve 11 is sheathed by the inner hole C71 of the speed control knob 2 and fixed by the hollow pin Al. The speed control knob 2 may be turned, so that the radial hole B65 of the flow control valve 11 and the radial hole A51 of the forward/reverse rotary valve 9 are misaligned, so as to control the airflow and achieve the speed control of the wrench.

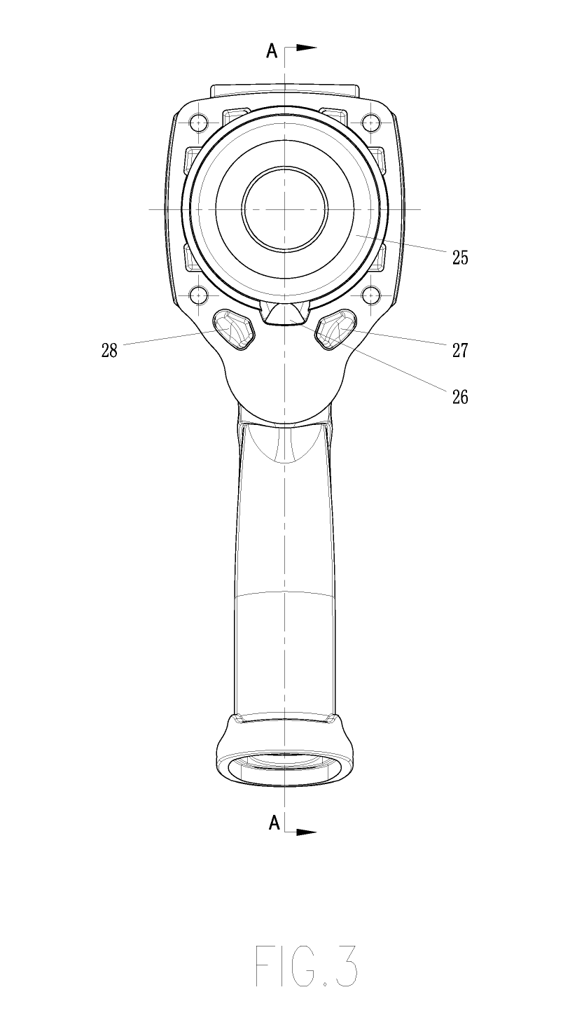

In FIGS. 3 to 6, an exhaust slot A26 is formed at the rear end surface of the casing 13 and communicated with the bottom of the large inner hole 25. The exhaust slot A26 of the casing 13 has an oblique exhaust hole 29 formed thereon and penetrated through the forward/reverse speed control assembly mounting hole 30 of the casing 13 and the exhaust hole 31 at the handle of the casing 13. Both sides of the exhaust slot 26A of the casing 13 have a forward air tank A27 and a reverse air tank A28 respectively. After assembling, the air tanks are communicated with the forward air tank B43 and the reverse air tank B44 formed on an end surface of the back cover 17. The handle of the casing 13 has an air intake hole 24 penetrated through an air chamber 32 formed at the bottom of the forward/reverse speed control assembly mounting hole 30. The forward/reverse speed control assembly mounting hole 30 of the casing 13 has a forward oblique hole 33 and a reverse oblique hole 34 formed therein, and the forward oblique hole 33 is penetrated from the outer side of the handle of the casing 13 to the forward air tank A27. Similarly, the reverse oblique hole 34 is penetrated to the reverse air tank A28 and the forward rotation hole 35 on a sidewall of the handle. The reverse rotation hole 36 has a plug 37 for sealing air.

A limiting hole 38 is formed and penetrated through the forward/reverse speed control assembly mounting hole 30 formed at the top of the casing 13, and a forward/reverse limiting projection 39 and two forward and reverse gear slots 40 are formed at the top of the front end of the forward/reverse speed control assembly mounting hole 30 of the casing 13, and a trigger module mounting hole 41 and a trigger module limiting hole 42 are formed at the bottom of the forward/reverse speed control assembly mounting hole 30 of the casing 13.

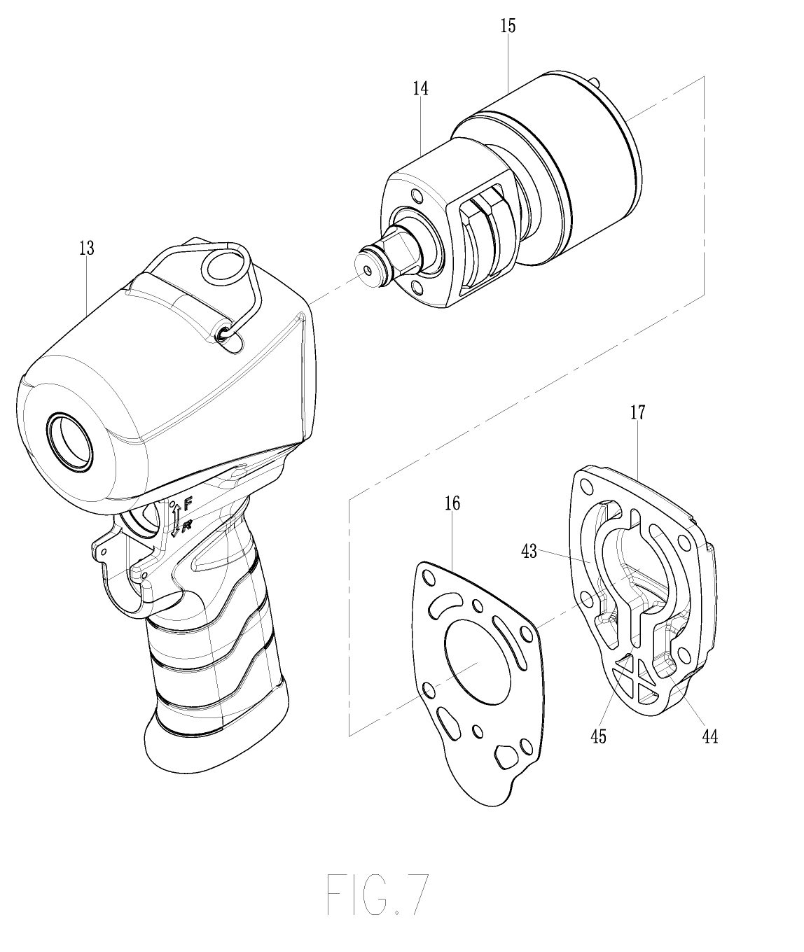

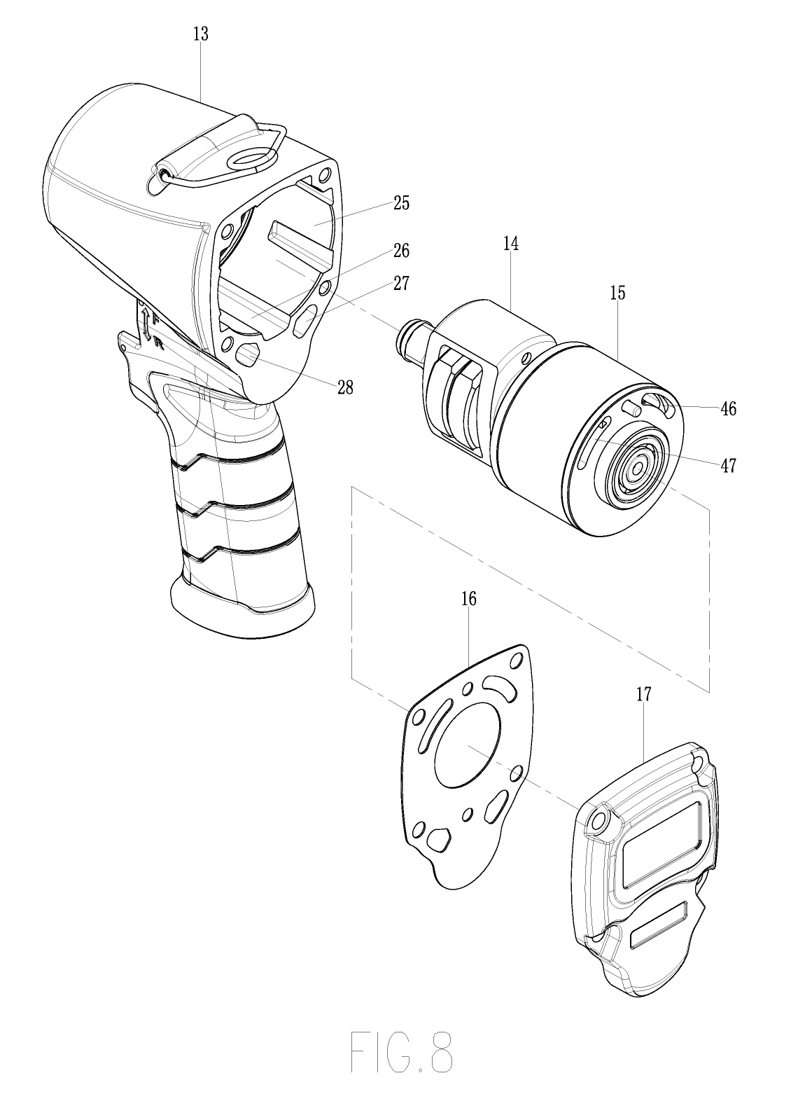

In FIGS. 7 and 8, a forward air tank B43, a reverse air tank B44, and an exhaust slot B45 are formed on an end surface of the back cover 17. After assembling, the forward air tank B43 and the reverse air tank B44 of the back cover 17 are communicated with the forward air tank A27 and the reverse air tank A28 of the casing 13 and the forward air tank C46 and the reverse air tank C47 of the motor module 15, and a back cover paper pad 16 is sealed between them.

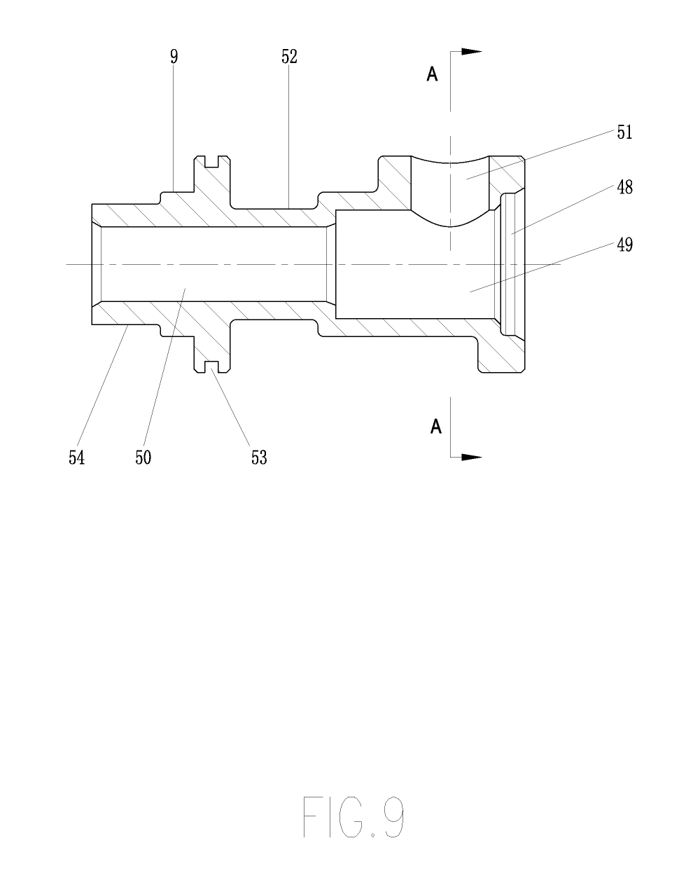

In FIGS. 9 to 12, and 14, the forward/reverse rotary valve 9 has a stepped inner hole A48, a stepped inner hole B49, and an inner hole A50 formed at the axis of the forward/reverse rotary valve 9. A radial hole A51, an exhaust slot C52, and a gasket slot 53 are formed at the external periphery of the forward/reverse rotary valve 9, and a double-planed square head 54 is formed at the external periphery of the small end, and the forward/reverse rotary valve 9 is installed in the forward/reverse speed control assembly mounting hole 30 of the casing 13, and the limiting hole 38 of the casing 13 is inserted with a hollow pin B20, so that the forward/reverse rotary valve 9 will not be blown out from the casing 13 by compressed air. The gasket slot 53 of the forward/reverse rotary valve 9 is installed with a gasket A8, so that the compressed air will not leak from the forward/reverse speed control assembly mounting hole 30 of the casing 13. When the radial hole A51 of the forward/reverse rotary valve 9 is communicated with the forward oblique hole 33 or the reverse oblique hole 34 of the casing 13, the reverse oblique hole 34 or the forward oblique hole 33 of the casing 13 is communicated with the exhaust slot C52 of the forward/reverse rotary valve 9.

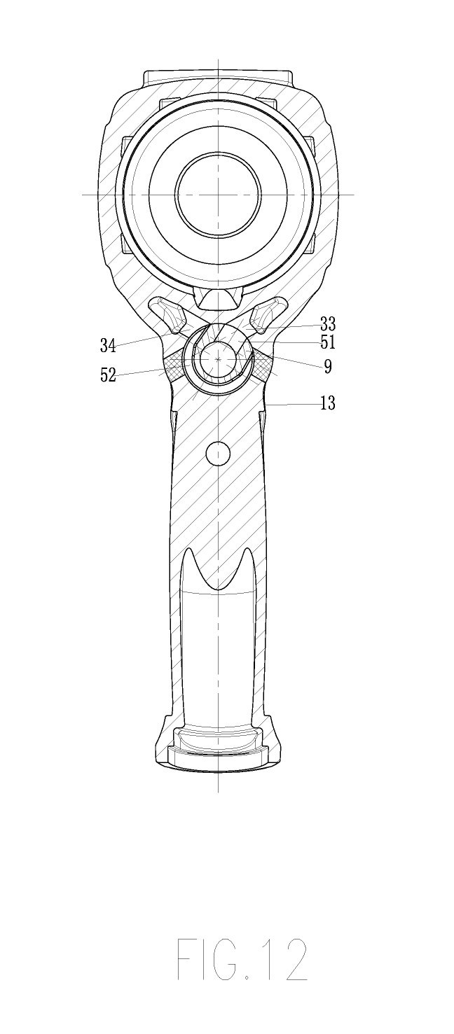

In FIGS. 12 to 15, both sides of the butterfly operating lever 5 have a side arm 55, and an end of the side arm 55 is in form of an inwardly arc 60, and a speed control gear label A56 is disposed on an end surface of the side arm 55. A latch groove 57 is formed at the middle of the butterfly operating lever 5, and a forward/reverse gear hole 58 is formed at the external periphery of the butterfly operating lever 5, and a speed control gear hole 59 is formed on an end surface of the butterfly operating lever 5. The gear spring A4 and the steel ball A3 are installed in the speed control gear hole 59 and operated together with the three recession holes 69 of the speed control knob 2 to control the speed control gear precisely. The gear spring B6 and the steel ball B7 are installed in the forward/reverse gear hole 58 and operated together with the forward and reverse gear slot 40 of the casing 13 to control the forward and reverse gear precisely. Both side arms 55 of the butterfly operating lever 5 are disposed at the bottom of the forward/reverse limiting projection 39 of the casing 13 to prevent an over-adjustment of the forward and reverse gears. The middle latch groove 57 of the butterfly operating lever 5 is operated together with the small-end square head 54 of the forward/reverse rotary valve 9. Both side arms 55 of the butterfly operating lever 5 may be turned to drive the middle latch groove 57 to rotate the forward/reverse rotary valve 9 automatically. When the steel ball B7 in the forward/reverse gear hole 58 is latched into the forward and reverse gear slot 40 of the casing 13 under the effect of the gear spring B6, the radial hole A51 at the external periphery of the forward/reverse rotary valve 9 is communicated with the forward oblique hole 33 or reverse oblique hole 34 of the casing 13 to switch to a forward or reverse rotation of the wrench.

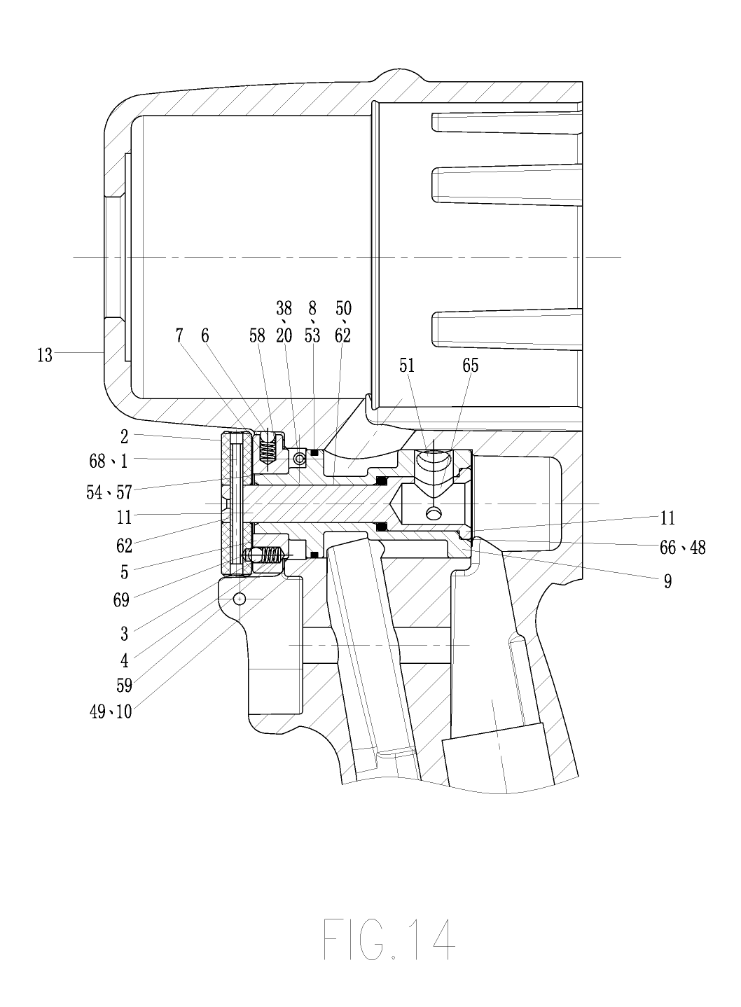

In FIGS. 14, 16, and 17, the flow control valve 11 has an inner hole B61 formed at the axis of the flow control valve 11. The external periphery of the flow control valve 11 is divided into three sections, wherein a positioning hole A63 is formed at a small section 62 of the external periphery of the flow control valve 11, and three different sized radial holes B65 are formed in a middle section 63 of the external periphery of the flow control valve 11, and the flow control valve 11 is passed into an inner hole A50 of the forward/reverse rotary valve 9, and a large section 66 of the external periphery of the flow control valve 11 is latched to the stepped inner hole A48 of the forward/reverse rotary valve 9 to prevent the flow control valve 11 from being blown away by compressed air. A gasket B 10 is installed to the small section 62 of the external periphery of the flow control valve 11 and sealed with the stepped inner hole B49 of the forward/reverse rotary valve 9 to prevent the compressed air from escaping out from the inner hole A50 of the forward/reverse rotary valve 9.

In FIGS. 14, 18 to 20, an anti-slip pattern 67 and a positioning hole B68 are formed at the external periphery of the speed control knob 2, and three recession holes 69 are formed on an end surface, and a speed control gear label

B70 is disposed on the other end surface. The inner hole C71 of the speed control knob 2 is operated together with the small section 62 of the external periphery of the flow control valve 11, and a hollow pin Al is installed into the positioning hole B68 and the positioning hole A63 of the flow control valve 11, so that the speed control knob 2 and the flow control valve 11 are combined as a whole. Now, an included angle is defined between the three recession holes 69 formed on the end surface of the speed control knob 2 and the three radial holes B65 formed at the external periphery of the flow control valve 11. The speed control knob 2 may be turned to rotate, so that the flow control valve 11 is driven to rotate altogether. When the speed control knob 2 is rotated until the steel ball A3 disposed in the speed control gear hole 59 on an end surface of the butterfly operating lever 5 is latched into a certain recession hole 69 on the end surface of the speed control knob 2 under the effect of the gear spring A4, the radial hole B65 corresponsive to the external periphery of the flow control valve 11 and the recession hole 69 of the speed control knob 2 is communicated with the radial hole A51 of the forward/reverse rotary valve 9 precisely, so as to control the airflow and achieve the speed control of the wrench.

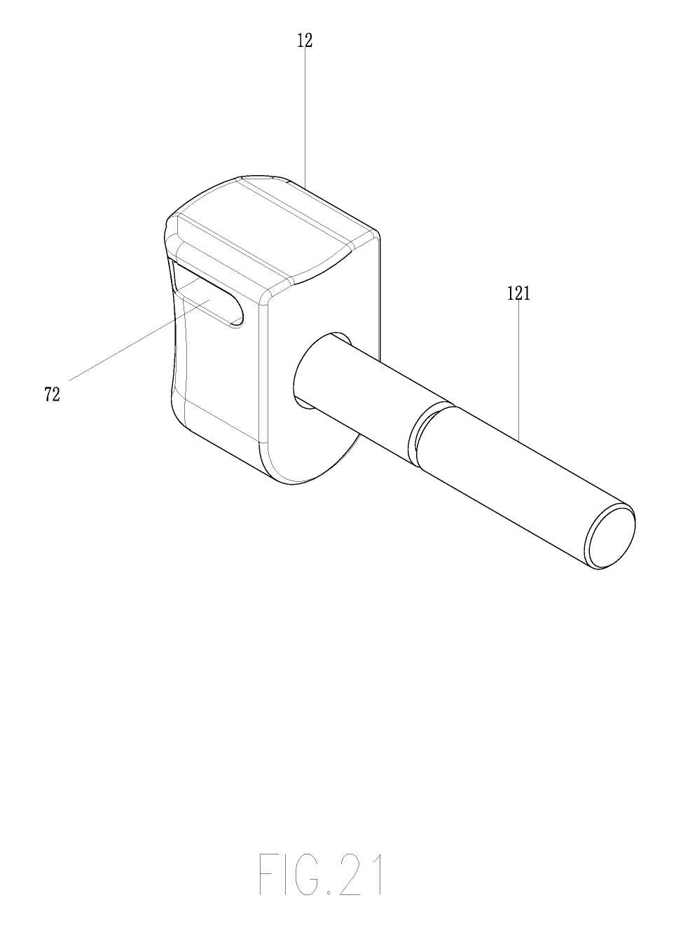

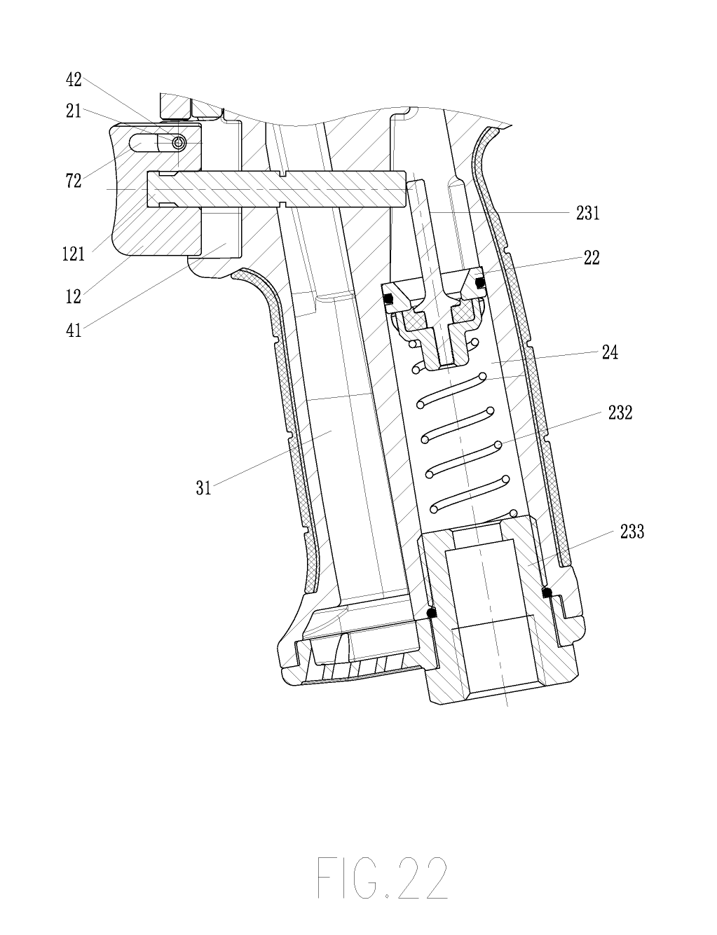

In FIGS. 21 and 22, an air intake ejector 121 is installed at a rear end of the trigger module 12, and a limiting groove 72 is formed at the top of the trigger module 12. During assembling, the trigger module 12 is installed into the trigger module mounting hole 41 of the casing 13, and the hollow pin C21 is installed into the trigger module limiting hole 42 of the casing 13 and passed into the limiting groove 72 of the trigger module 12 to prevent the trigger module 12 from separating from the casing 13 while using the pneumatic wrench. When the trigger module 12 is pressed, the air intake ejector 121 is pushed to open the air intake valve 231 in the air seal module 23 to input air and operate the wrench. When the external force of the trigger module 12 is released, the trigger module 12 is pushed by the air intake valve 231 to resume its original position under the effect of the return spring 232 in the air seal module 23, so that the air intake valve 231 and the air seal washer 22 resume their air seal status. Now, the wrench stops its operation.

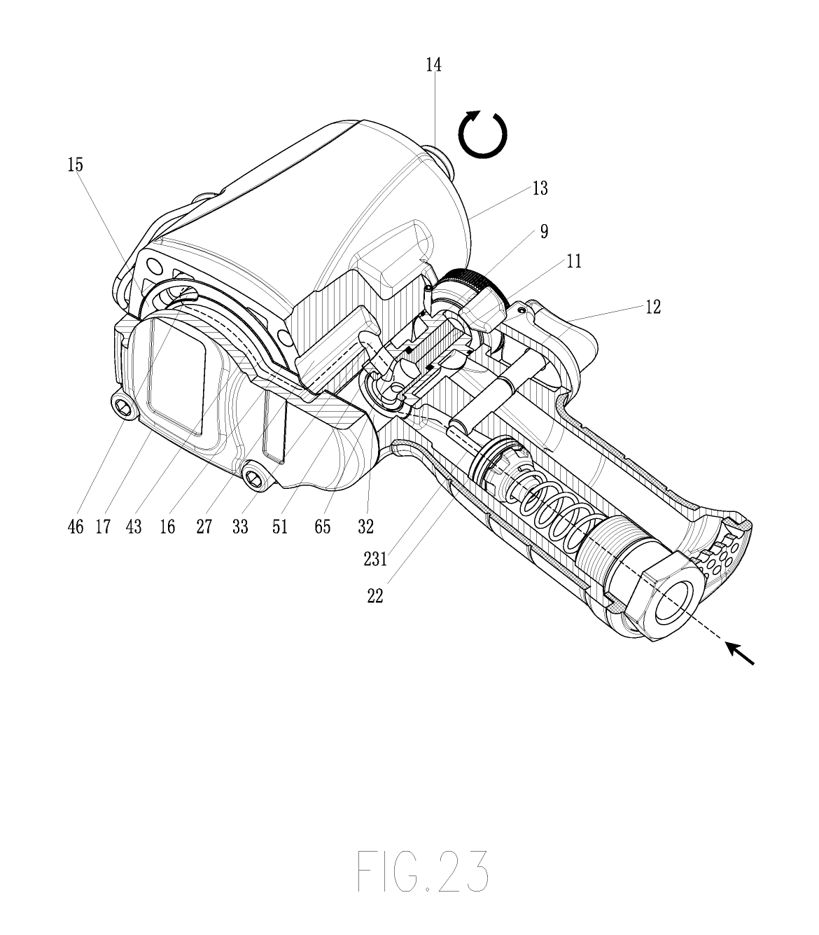

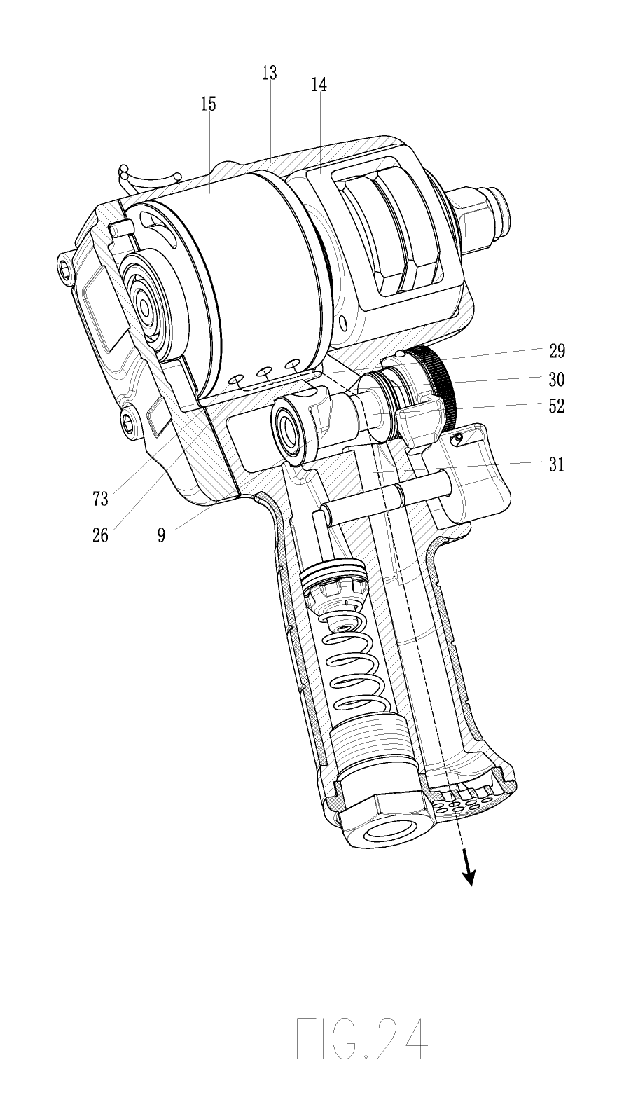

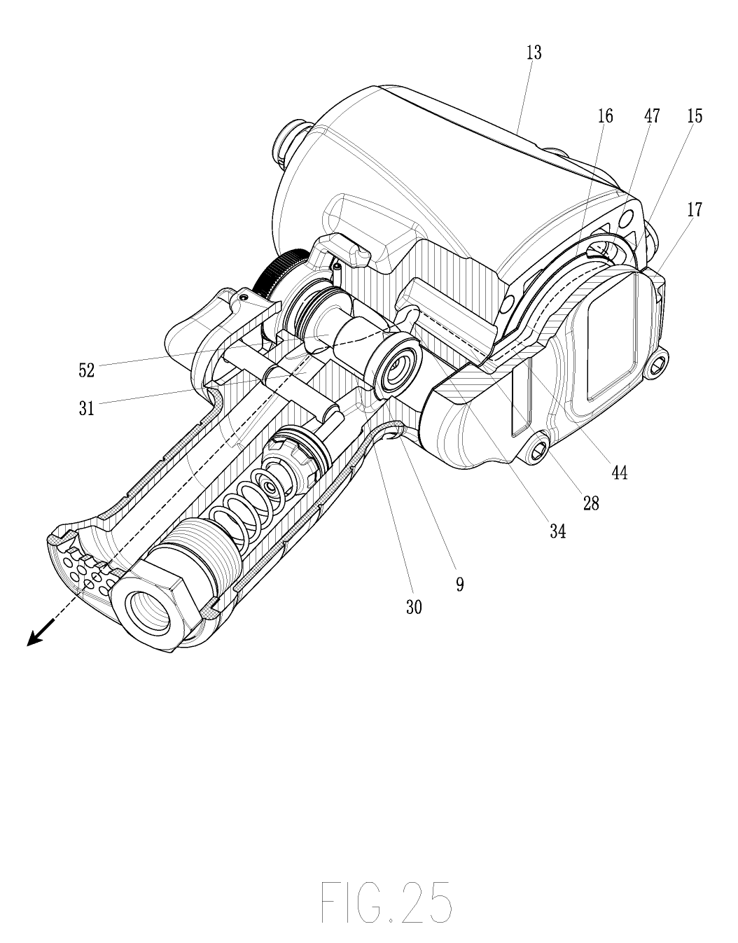

In FIGS. 23 to 25, the airflow of the pneumatic wrench with a butterfly steering switching mechanism the present invention during its operation is described below:

1. In the air intake process, after the trigger module 12 is pressed, the air intake valve 231 is pushed open, and compressed air is passed through the air seal module 23 and the air seal washer 22 to enter into the air chamber 32 of the casing 13 through the radial hole B 65 of the flow control valve 11, the radial hole A 51 of the forward/reverse rotary valve 9, the forward oblique hole 33 of the casing 13 to the forward air tank A 27 of the casing 13, and then to enter into the motor module 15 through the back cover paper pad 16, the forward air tank B 43 of the back cover 17, and the forward air tank C 46 of the motor module 15, so that the motor module 15 drives the striking module 14 to rotate clockwise.

In the air exhaust process, the air exhaust process is divided into two sections:

\textcircled{1} CD Some of the exhaust air is discharged from the exhaust hole 73 of the motor module 15 and entered into the forward/reverse speed control assembly mounting hole 30 of the casing 13 through the casing exhaust slot A 26 and the oblique exhaust hole 29 of the casing 13, and passed around the exhaust slot C 52 of the forward/reverse rotary valve 9 and entered into the exhaust hole 31 of the handle of the casing 13, and finally discharged to the outside. \textcircled{2} The remaining exhaust air is discharged from the reverse air tank C 47 of the motor module 15, and passed through the back cover paper pad 16 into the reverse air tank B 44 of the back cover 17, the reverse air tank A 28 of the casing 13, the reverse oblique hole 34 of the casing 13, the forward/reverse speed control assembly mounting hole 30 of the casing 13, and passed around the exhaust slot

C 52 of the forward/reverse rotary valve 9 into the exhaust hole of the handle of the casing, and finally discharged to the outside. The compressed air flows along the aforementioned path to keep a continual operation of the wrench. When it is necessary to switch the rotating direction, the operator simply turns the butterfly operating lever to the other side, and the principle of operation is the same as described above.

The structure and operating principle of the pneumatic wrench with a butterfly steering switching mechanism of the present invention is described by exemplary embodiments and illustrated by related drawings, but persons having ordinary skills in the art may make modifications based on the basis of these embodiments. For example, the side arms 55 disposed on both sides of the butterfly operating lever 5 may be changed to one side arm 55, or the shape of the side arm may be changed. The black of the casing 13 formed by pressure casting may be changed to gravitational casting to overcome the air passed formed on the sidewall of the handle, and an additional component such as a sleeve may be added between the forward/reverse rotary valve 9 and the forward/reverse speed control element mounting hole 30 of the casing 13, and gaskets are added to the external periphery of the forward/reverse rotary valve 9.

While the invention has been described by means of specific embodiments, numerous modifications and variations could be made thereto by those skilled in the art without departing from the scope and spirit of the invention set forth in the claims.

What is claimed is:

1. A pneumatic wrench with a butterfly steering switching mechanism, comprising a casing, a striking module, a motor module, a back cover, a back cover paper pad, an air seal module, an air seal washer, a forward/reverse speed control assembly, a trigger module, a hollow pin C, a screw, and a spring washer, characterized in that the casing includes a handle disposed at the bottom of the casing, an air intake hole formed on the handle, and an air seal washer pressed into the air intake hole, and the air seal module is locked securely into the air intake hole by a pipe joint and naturally situated in an always closed status; and the casing has a large inner hole therein and provided for serially and sequentially installing the striking module and the motor module, and the back cover is provided for sealing the motor module and the striking module in the casing by using a plurality of screws and a plurality of spring washers, and a back cover paper pad is sealed between the casing and the back cover, and an exhaust slot A, a forward air tank A and a reverse air tank A are disposed on the rear surface of the casing, and a forward air tank B and a reverse air tank B are disposed on an end surface of the back cover, and the forward air tank A and the reverse air tank A of the casing are corresponsive to the forward air tank B and reverse air tank B of the back cover, and the motor module includes a forward air tank C and a reverse air tank C corresponsive to the forward air tank B and the reverse air tank B disposed on an end surface of the back cover, and the casing has a trigger module mounting hole formed at the front of the casing and provided for installing the trigger module therein, and an air intake ejector installed at the rear of the casing, and the air seal module includes an air intake valve, a return spring and a pipe joint, such that when the trigger module is pressed, the air intake ejector pushes and opens the air intake valve in the air seal module to drive the pneumatic wrench to input air and operate, and when the trigger module is released, the air intake valve and the trigger module resume their natural status to achieve the effect of stopping the operation of the pneumatic wrench under the effect of the return spring in the air seal module, and a forward/reverse speed control assembly mounting hole is formed above the trigger module mounting hole of the casing and has a forward/reverse speed control assembly formed therein, and the forward/reverse speed control assembly includes a hollow pin A, a speed control knob, a butterfly operating lever, a forward/reverse rotary valve, a gasket A and a flow control valve, and the speed control knob and the butterfly operating lever are disposed outside the forward/reverse speed control assembly mounting hole, and the forward/reverse rotary valve and the flow control valve are installed in the forward/reverse speed control assembly mounting hole, and the speed control knob includes an inner hole C, and a latch groove is formed at the middle of the butterfly operating lever, and a small end of the forward/reverse rotary valve is substantially a square head, and the latch groove of the butterfly operating lever is operated closely with the square head of the forward/reverse rotary valve, and the butterfly operating lever may be turned to drive the forward/reverse rotary valve to be rotated axially, so as to achieve the effect of switching to a forward or reverse rotation of the wrench; and a radial hole A is formed at the external periphery of the forward/reverse rotary valve, and an inner hole A is formed in the forward/reverse rotary valve, and three different sized radial holes are formed at the external periphery of the flow control valve, and a small end of the flow control valve is passed through the gasket B and sheathed by the inner hole A of the forward/reverse rotary valve, and a passing-out end of the flow control valve is sheathed by the inner hole C of the speed control knob And fixed by the hollow pin A, and the speed control knob may be turned to produce a misalignment of the valve radial hole B of the flow control with the radial hole A of the forward/reverse rotary valve to control the airflow to achieve the speed control of the wrench.

2. The pneumatic wrench with a butterfly steering switching mechanism according to claim 1, wherein the casing has an exhaust slot A formed on a rear surface of the casing and communicated with the bottom of the large, and an exhaust oblique hole is drilled at the exhaust slot A of the casing and penetrated through the exhaust hole at the forward/reverse speed control assembly mounting hole and the handle of the casing, and both sides of the exhaust slot A of the casing have a forward air tank A and a reverse air tank A, and the air tanks are communicated with the forward air tank B and the reverse air tank B formed on an end surface of the back cover, and the handle of the casing has an air intake hole penetrated through an air chamber at the bottom of the forward/reverse speed control assembly mounting hole, and the forward/reverse speed control assembly mounting hole of the casing has a forward oblique hole and a reverse oblique hole formed therein, and the forward oblique hole is penetrated from the outer side of the handle of the casing handle to the forward air tank A, and the reverse oblique hole is similarly penetrated to the reverse air tank A, and a forward rotation hole and a reverse rotation hole formed on a sidewall of the handle have a plug for sealing the air, and a limiting hole is formed at and penetrated through the forward/reverse speed control assembly mounting hole; and a forward/reverse limiting projection and two forward and reverse gear slots are formed at the top of the front end of the forward/reverse speed control assembly mounting hole of the casing, and a trigger module mounting hole and a trigger module limiting hole are formed at the bottom of the forward/reverse speed control assembly mounting hole.

3. The pneumatic wrench with a butterfly steering switching mechanism according to claim 1, wherein the back cover has a forward air tank B, a reverse air tank B and an exhaust slot B disposed on an end surface of the back cover, and the forward air tank B and the reverse air tank B of the back cover are communicated with the forward air tank A and the reverse air tank A of the casing and the forward air tank C and the reverse air tank C of the motor module, a back cover paper pad is sealed between them.

4. The pneumatic wrench with a butterfly steering switching mechanism according to claim 1, wherein the forward/reverse rotary valve includes an inner hole A, a platform inner hole and a platform inner hole B formed on the forward/reverse rotary valve, and a radial hole A, an exhaust slot C and a gasket slot are formed at the external periphery of a large end of the external forward/reverse rotary valve, and a double-planed square head is formed at the external periphery of a small end of the external periphery of the forward/reverse rotary valve, and the forward/reverse rotary valve is installed in the forward/reverse speed control assembly mounting hole of the casing, and the limiting hole of the casing is inserted with a hollow pin B, so that the forward/reverse rotary valve will not be blown away and out from the casing by the compressed air, and when a gasket A is installed into a gasket slot of the forward/reverse rotary valve, the compressed air will not leak from the forward/reverse speed control assembly mounting hole of the casing, and when the radial hole A of the forward/reverse rotary valve is communicated with the forward oblique hole or the reverse oblique hole of the casing, the reverse oblique hole or the forward oblique hole of the casing is communicated with the exhaust slot C of the forward/reverse rotary valve.

5. The pneumatic wrench with a butterfly steering switching mechanism according to claim 1, wherein the butterfly operating lever includes two side arms disposed at both sides of the butterfly operating lever respectively, and an end of the side arm is in the shape of an inwardly concave arc, and a speed control gear label A is situated at an end surface of the side arm of the butterfly operating lever, and a latch groove is formed at the middle of the butterfly operating lever, and a forward/reverse gear hole is formed at the external periphery of the butterfly operating lever, and a speed control gear hole is formed at an end surface of the butterfly operating lever, and the gear spring A and the steel ball A are installed in the speed control gear hole and operated together with the three recession holes of the speed control knob for controlling the speed control gears precisely, and the gear spring B and the steel ball B are installed in the forward/reverse gear hole and operated together with the forward and reverse gear slot of the casing for controlling the forward/reverse gears precisely, and the two side arms of the butterfly operating lever are situated at the bottom of the forward/reverse limiting projection of the casing to prevent an over-adjustment of the forward/reverse gear, and the latch groove at the middle of the butterfly operating lever is configured closely with the small-end square head of the forward/reverse rotary valve, so that when the two side arms of the butterfly operating lever are turned, the middle latch groove drives the forward/reverse rotary valve to rotate automatically, and when the steel ball B in the forward/reverse gear hole is latched into the forward and reverse gear slot of the casing under the effect of the gear spring B, the radial hole A at the external periphery of the forward/reverse rotary valve is communicated precisely with a forward oblique hole or a reverse oblique hole of the casing to switch to a forward/reverse rotation.

6. The pneumatic wrench with a butterfly steering switching mechanism according to claim 1, wherein the flow control valve includes an inner hole B formed at the axis of the flow control valve, and the external periphery of the flow control valve is divided into three section, and a positioning hole A is formed in a small section of the external periphery, and three different sized radial holes B are formed in a middle section of the external periphery, and the flow control valve is passed into the inner hole A of the forward/reverse rotary valve, and a large section of the external periphery latches at the platform inner hole A of the forward/reverse rotary valve to prevent the flow control valve from being blown away by the compressed air, and a gasket B is installed at the small section of the external periphery of the flow control valve and sealed with the platform inner hole B of the forward/reverse rotary valve to prevent the compressed air from escaping from the inner hole A of the forward/reverse rotary valve.

7. The pneumatic wrench with a butterfly steering switching mechanism according to claim 1, wherein the speed control knob includes an anti-slip pattern and a positioning hole B formed at the external periphery of the speed control knob, three recession holes formed on an end surface of the speed control knob and a speed control gear label B disposed at the other end surface of the speed control knob, and the speed control knob inner hole C is in matched with a small section of the external periphery of the flow control valve, and the hollow pin A is installed into the positioning hole B and the flow control valve positioning hole A, so that the speed control knob and the flow control valve are combined as a whole, and a specific included angle is defined between the three recession holes on the end surface of the speed control knob and the three radial holes B at the external periphery of the flow control valve define, and when the speed control knob is rotated, the flow control valve is driven to rotate altogether, and when the speed control knob is rotated and latched into the recession hole on the end surface of the speed control knob, and the steel ball A in the speed control gear hole formed on the end surface of the butterfly operating lever is situated at an end surface under the effect of the gear spring A, the radial hole B configured to be corresponsive to the external periphery of the flow control valve and the recession hole of the speed control knob are and communicated precisely with the radial hole A of the forward/reverse rotary valve, so as to control the airflow to adjust the speed of the wrench.

8. The pneumatic wrench with a butterfly steering switching mechanism according to claim 1, wherein the trigger module includes an air intake ejector installed at an end of the trigger module, and a limiting groove formed at the top of the trigger module, and the trigger module is installed into the trigger module mounting hole of the casing, and the hollow pin A is installed into the trigger module limiting hole of the casing and passed through the trigger module limiting groove for preventing the trigger module from separating from the casing while using the pneumatic wrench, and when the trigger module is pressed, the air intake ejector pushes and opens the air intake valve in the air seal module to inputting air to the wrench, and when the external force of the trigger module is released, the trigger module is pushed by the air intake valve to resume its original position due to the effect of the return spring in the air seal module, and the wrench stops operating when the air intake valve and the air seal washer recover the air seal status.
